(19) United States
(12) Patent Application Publication
(10) Pub. No.: US 2018/0372150 A1
(43) Pub. Date: Dec. 27, 2018

(54) MECHANISM FOR ADJUSTING AN AVERAGE SPEED IN A TIMEPIECE MOVEMENT AND TIMEPIECE MOVEMENT

(71) Applicant: Société anonyme de la Manufacture d"horlogerie Audemars Piguet & Cie, Le Brassus (CH)

(72) Inventors: Giulio PAPI, La Chaux-de-Fonds (CH); Nicolò ROBUSCHI, Noceto (IT)

(21) Appl. No.: 16/061,939

(22) PCT Filed: Dec. 15, 2016
(86) PCT No.: PCT/EP2016/081132

§ 371 Date: Jun. 13, 2018

(30) Foreign Application Priority Data
Dec. 16, 2015 (EP) 15200453.7

(51) Int. Cl. F16C 11/12; G04B 15/14; G04B 17/04; G04B 17/06; G04B 13/02

(52) U.S. Cl. CPC F16C 11/12; G04B 15/14; G04B 17/045; G04B 31/00; G04B 13/02; F16C 2370/00; G04B 17/063

(57) ABSTRACT

A mechanism for adjusting an average speed in a timepiece movement comprises an escapement wheel and a mechanical oscillator, in which a plurality of blades, which are resiliently flexible in an oscillation plane, support and return a balance in such a way that this balance oscillates at an angle in the oscillation plane. A pallet fork comprises two rigid pallets which are rigidly connected to the balance and are arranged to co-operate alternately with a toothing of the escapement wheel when the balance oscillates at an angle.

### TECHNICAL FIELD OF THE INVENTION

This invention relates to the field of mechanical watchmaking. More specifically, it concerns a mechanism for adjusting an average speed in a timepiece movement as well as a timepiece movement.

### STATE OF THE ART

In a timepiece movement, a motor element, such as a mainspring, provides the driving energy which a going train transmits to the escapement wheel of an escapement interacting with the mechanical oscillator. The speeds of the gears in the going train are all proportional to a speed of rotation, which is the average speed of rotation of the escapement wheel. The average speed of rotation of this escapement wheel is determined by the oscillations of the mechanical oscillator. More precisely, the function of the mechanical oscillator is to provide the rate at which the angular pitches of the escapement wheel succeed one another. This rate must be as stable as possible.

In the Swiss patent application CH 709 291 (also published as U.S. Pat. No. 9,207,641), proposed is a mechanical oscillator without spiral spring nor mounting arbor. Its balance is borne by a plurality of resiliently flexible blades. The balance pivots on itself, through a flexion of the resiliently flexible blades which return this balance toward a dead point, in addition to supporting it. The resiliently flexible blades are offset with respect to one another in the direction of the thickness of the balance. They cross at ⅞th of their respective lengths.

Described in the European patent application EP 1 736 838 is the association of an escapement and an oscillator in which the balance is borne by a plurality of resiliently flexible blades. The escapement comprises a transmission organ which is fixed to the balance. Two elastic fingers of this transmission organ co-operate alternately with the toothing of an escapement wheel. The oscillation frequency of the balance depends to a large extent on the degree of winding of a mainspring constituting the motor organ. This detracts from the precision of time counting since the degree of winding of the mainspring is not constant over time.

### SUMMARY OF INVENTION

The invention has at least as object to enable a reduction or even an elimination to be obtained of friction being produced at the support of a balance of a mechanical oscillator without the precision of a timepiece movement operating with the aid of this mechanical oscillator being overly affected by the degree of winding of the motor organ.

This object is attained through a mechanism for adjustment of an average speed in a timepiece movement. This adjustment mechanism comprises an escapement wheel and a mechanical oscillator. This mechanical oscillator comprises a balance and a plurality of resiliently flexible blades which are resiliently flexible in a plane of oscillation and which support and return the balance in such a way that this balance oscillates at an angle in the plane of oscillation. The adjustment mechanism includes a pallet fork comprising two rigid pallets which are rigidly connected to the balance and arranged to co-operate alternately with a toothing of the escapement wheel when the balance oscillates at an angle.

During operation, the drive motor torque of the escapement wheel does not interfere, or practically does not interfere, with the oscillations of the balance, except during the impulse phases. It has been noted that this makes the precision of time counting less dependent upon the degree of winding of the motor organ.

Moreover, the resiliently flexible blades can easily be arranged so that the oscillations of the balance have an amplitude compatible with the use of an escapement in which the pallet fork comprises two pallets that are rigid and rigidly connected to the balance.

The adjustment mechanism defined above can incorporate one or more other advantageous features, individually or in combination, in particular from among those specified hereinafter.

Preferably, each pallet includes an upstream side forming a resting surface to block successively the teeth of the toothing toward the downstream counter to a driving motor torque of the escapement wheel, each pallet including an end surface forming an impulse surface to receive successively impulses from the toothing.

Preferably, each resting surface curves toward the other resting surface. When such is the case, the precision of time counting is most often even less dependent upon the degree of winding of the motor organ.

Preferably, each resting surface curves toward the other resting surface in a way so as to be able to slide on a tooth of the toothing, during an angular oscillation of the balance, while not causing or substantially not causing rotation movement of the escapement wheel. When such is the case the precision of time counting is even less dependent upon the degree of winding of the motor organ.

Preferably, each resting surface has a substantially constant curvature in the direction of its length and has a center of curvature always positioned substantially at the same place, substantially on a virtual pivot axis of the balance. When such is the case, the precision of time counting is even less dependent upon the degree of winding of the motor organ.

Preferably, the mechanical oscillator comprises a mounting base.

Preferably, at least part of the resiliently flexible blades each comprise an end rigidly joined to the mounting base. Preferably, at least part of the resiliently flexible blades each comprise an end rigidly joined to the balance.

Preferably, at least a first and a second resiliently flexible blade among the resiliently flexible blades each comprises two opposite ends, i.e. a first end rigidly joined to the mounting base and a second end. Preferably, at least a third and a fourth resiliently flexible blade among the resiliently flexible blades each comprise two opposite ends, i.e. a first end rigidly joined to the balance and a second end. Preferably, the second ends of the first, second, third and fourth resiliently flexible blades at least are rigidly joined to one another.

It has been found that in the case defined in the preceding paragraph, the return torque that the first, second, third and fourth resiliently flexible blades exert together on the balance is proportional in an overall way to the angular displacement of the balance starting from a dead point position and that this contributes to a good isochronism of the mechanical oscillator. Still in the case defined in the preceding paragraph, it is easy to obtain a situation where the oscillations of the balance have an amplitude compatible with the use of a dead-beat escapement.

Preferably, the second ends of the first, second, third and fourth resiliently flexible blades are rigidly joined to one another by a coupling part.

Preferably, the first ends of the first and second resiliently flexible blades are angularly offset one with respect to the other by an angle ranging between 80° and 150°, about an axis perpendicular to the plane of oscillation and centered on the coupling part, the first ends of the third and fourth resiliently flexible blades being angularly offset one with respect to the other by an angle ranging between 80° and 150°, about the axis perpendicular to the plane of oscillation and centered on the coupling part.

When it is so, the angular oscillations of the balance in the plane of oscillation, about a virtual pivot axis, are favored whereas disfavored are the other vibrational modes, that is to say parasitic vibrational modes.

Preferably, the first ends of the first and second resiliently flexible blades are offset one with respect to the other by an angle on the order of 120°, about the axis perpendicular to the plane of oscillation and centered on the coupling part, the first ends of the third and fourth resiliently flexible blades being angularly offset one with respect to the other by an angle on the order of 120°, about the axis perpendicular to the plane of oscillation and centered on the coupling part.

When it is so, the angular oscillations of the balance in the plane of oscillation, about a virtual pivot axis, are favored whereas disfavored are the other vibrational modes, that is to say parasitic vibrational modes.

Preferably, at least part of the mounting base, at least part of the balance and the resiliently flexible blades form part of a same single piece, i.e. are integral with one another. When such is the case, a compact solution can be obtained. It can be at reduced cost insofar as the resiliently flexible blades, at least part of the mounting base and at least part of the balance can be achieved at the same time with the same apparatus or apparatuses. Moreover, a reduction of the components to be assembled can likewise be obtained. In addition, an increased precision can be obtained with respect to the geometry of the assembly, in particular when the same single piece is achieved by means of the DRIE (deep reactive-ion etching) method or the LIGA method (lithography, electroplating and molding).

Preferably, at least part of the mounting base, at least part of the balance and the resiliently flexible blades are made of silicon and/or silicon oxide.

Preferably, the second ends of the first, second, third and fourth resiliently flexible blades are rigidly joined to one another by a coupling part through which passes a virtual pivot axis of the balance.

Preferably, the coupling part is located substantially at equal distance from the first ends of the first, second, third and fourth resiliently flexible blades.

Preferably, the balance has a center of gravity located substantially at the coupling part.

Preferably, the first and second resiliently flexible blades are substantially symmetrical with respect to one another in relation to a plane. Preferably, the third and fourth resiliently flexible blades are substantially symmetrical between them with respect to this plane.

Preferably, the first and third resiliently flexible blades extend in a same plane perpendicular to the plane of oscillation. Preferably, the second and fourth resiliently flexible extend in a same plane perpendicular to the plane of oscillation.

Preferably, the mounting base comprises two stops which are travel end stops for the balance and which define a maximal angular course of the balance by preventing this balance from going beyond two opposite ends of this maximal angular course. When such is the case, the two resiliently flexible blades are protected against a deterioration resulting from too great a deformation, such as a deformation following a shock.

Preferably, the balance includes two opposite wings and a crosspiece connecting these two wings together, at least part of the resiliently flexible blades each comprising an end rigidly joined to the said crosspiece. When such is the case, the mounting base or an equivalent thereof cannot be surrounded by the balance, which offers a much greater freedom of design.

In addition, the invention has as an object a timepiece movement comprising a motor organ, a gear train driven by the motor organ, and an adjustment mechanism such as defined in the foregoing, the escapement wheel being driven by the gear train.

### BRIEF DESCRIPTION OF THE DRAWINGS

Other advantages and features will emerge more clearly from the description which follows of a particular embodiment of the invention, given by way of non-limiting example and represented in the attached drawings, among which:

FIG. 1 is a schematic view of a timepiece movement according to one embodiment of the invention,

FIG. 2 is a top view of an adjusting mechanism in which an escapement and a mechanical oscillator according to one embodiment of the invention are associated in such a way as to be able to interact to adjust the average speeds of rotation in a going train of the timepiece movement of FIG. 1,

FIG. 3 is a top view in which the mechanical oscillator of the adjusting mechanism of FIG. 2 is represented alone, without the escapement,

FIG. 4 is a perspective view representing the same mechanical oscillator as FIG. 3, as well as a pallet fork which is fixed to a balance of this mechanical oscillator and which forms part of the escapement visible in FIG. 2,

FIG. 5 is an enlargement of a partial view taken from a top view representing the same subassembly resulting from the association of a mechanical oscillator and a pallet fork as in FIG. 4, and

FIGS. 6 to 9 represent the same adjusting mechanism as FIG. 2 and show the successive positions that the balance of the mechanical oscillator, the pallet fork and the escapement wheel occupy in the course of one of several identical cycles repeating themselves in operation.

### DESCRIPTION OF A PREFERRED EMBODIMENT OF THE INVENTION

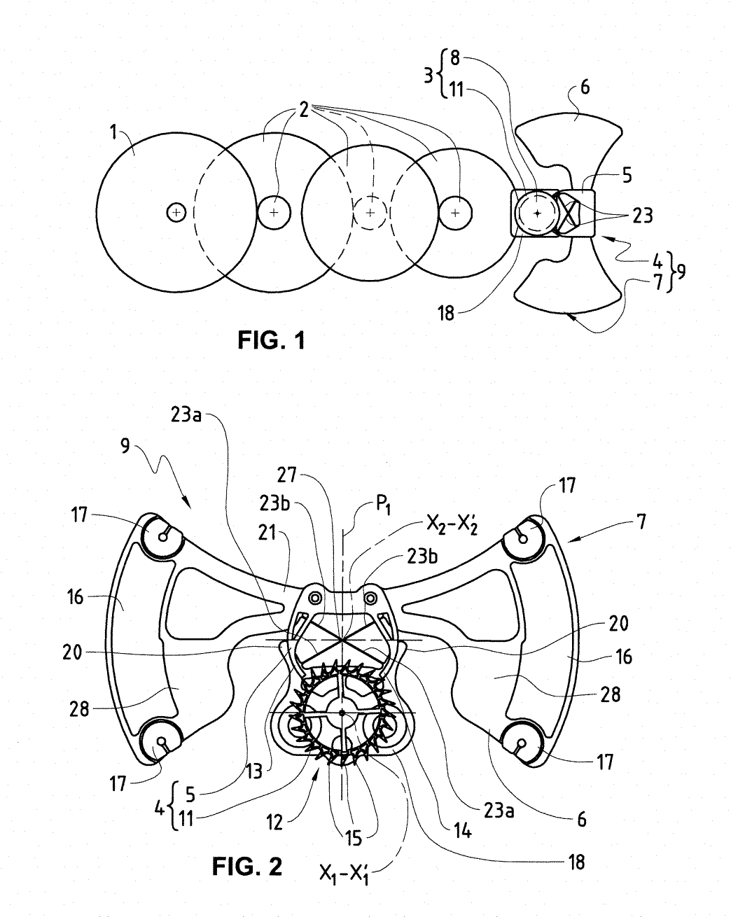

In FIG. 1, a timepiece movement according to one embodiment of the invention comprises a barrel 1, whose motor organ (not shown) such as a balance spring, produces torque and which, as a result of this torque, drives a going train 2. This going train 2 drives, for its part, an escapement mobile 3, which forms part of an escapement 4 comprising moreover a pallet fork 5. This pallet fork 5 is borne by the balance 6 of a mechanical oscillator 7.

A plate (not shown) or a frame of another type bears the barrel 1, the escapement mobile 3, the mechanical oscillator 7 and the going train 2, whose mobiles can be held in place in a manner known per se, by bars or bridges (likewise not shown). The escapement mobile 3 comprises a pinion 8, which meshes with a wheel of the going train 2.

In FIG. 2, the escapement 4 and the mechanical oscillator 7 are associated in such a way as to form together a mechanism 9 for adjusting the average speed of rotation in the timepiece movement of FIG. 1. The escapement 4 is a dead-beat escapement. Rotating on an axis of rotation X₁-X′_{1,} its escapement mobile 3 comprises, besides the pinion 8, an escapement wheel 11 including a peripheral toothing 12, which is provided to co-operate alternately with an entry pallet 13 and an exit pallet 14 of the pallet fork 5.

The toothing 12 is made up of a succession of triangular teeth 15, each one of which terminates in a substantially pointed free end.

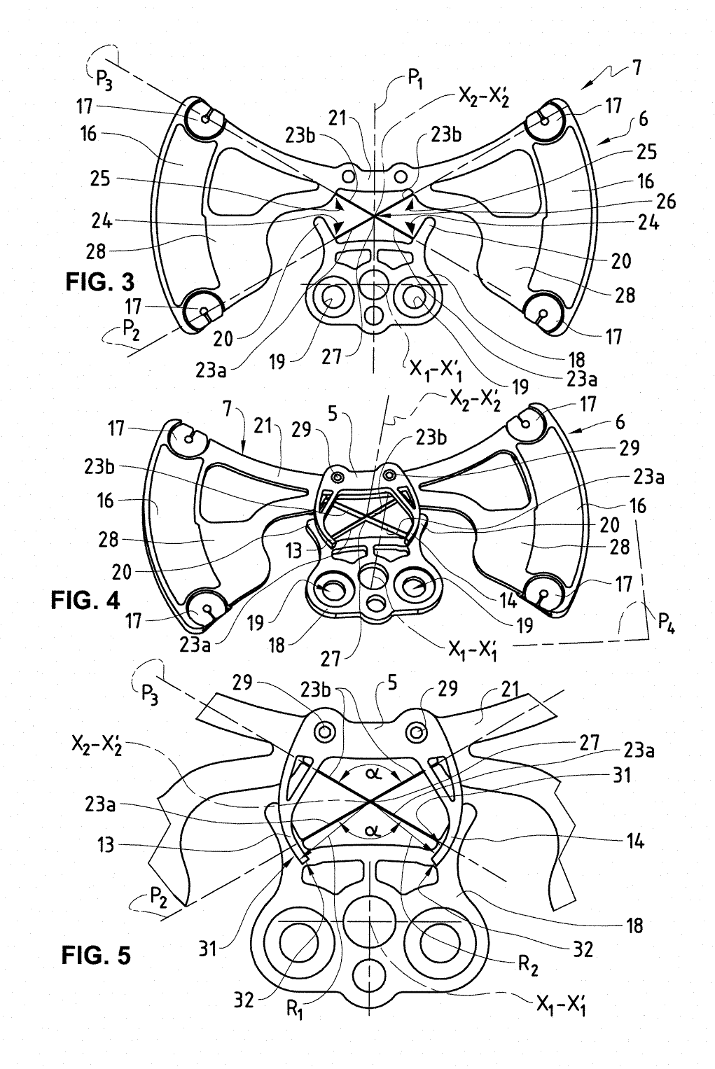

As can be seen in FIGS. 3 and 4, the mechanical oscillator 7 is symmetrical with respect to a plane of symmetry P₁. Essentially, that is to say with the exception of the inertia blocks 16 and 17 which bear its balance 6, this mechanical oscillator 7 is flattened and extends in a plane P₄ perpendicular to the plane of symmetry P₁. This plane P₄ is the plane of the sheet of FIG. 3.

The mechanical oscillator 7 comprises a fixed mounting base 18, which takes the form of a plate and which is intended to be fixed rigidly to the plate of the timepiece movement, by means of screws (not shown) or other fixing members. Through holes 19 for the passage of such screws are pierced into the mounting base 18, in the direction of its thickness. This mounting base 18 comprises two lateral fingers, which form angular travel end stops 20 for the balance 6 and which are directed toward a crosspiece 21 of this balance 6.

A constituent elastic articulation of the mechanical oscillator 7 comprises a first resiliently flexible blade 23a, a second resiliently flexible blade 23a, a third resiliently flexible blade 23b, a fourth resiliently flexible blade 23b and a coupling part 27. This elastic articulation connects the mounting base 18 to the crosspiece 21. It bears the balance 6 while being itself borne by the mounting base 18. The mounting base 18, the resiliently flexible blades 23a and 23b, the coupling part 27 and the balance 6, with the exception of the inertia blocks 16 and 17, form part of a same single piece, i.e. are integral with one another.

The resiliently flexible blades 23a are substantially symmetrical one with respect to the other in relation to a plane of symmetry P₁. The same applies for the resiliently flexible blades 23b.

Each resiliently flexible blade 23a comprises a first end 24, at which it is rigidly connected on the mounting base 18. In other words, each resiliently flexible blade 23a is joined to the mounting base 18 through an embedded-type connection. Each resiliently flexible blade 23b comprises a first end 25, at which it is rigidly connected to the crosspiece 21. In other words, each resiliently flexible blade 23b is joined to the crosspiece 21 through an embedded-type connection.

Opposite its first end 24 or 25, each of the resiliently flexible blades 23a and 23b comprises a second end 26 and is connected on the rigid coupling part 27 at this second end 26. The two ends 26 of the resiliently flexible blades 23a and 23b are rigidly joined with respect to one another.

Each of the resiliently flexible blades 23a and 23b extends along a ruled surface all the straight lines forming the generatrix of which are perpendicular to the plane P₄ of the mechanical oscillator 7. The blades 23a and 23b are thus resiliently flexible in the plane P₄ and they allow angular oscillations of the balance 6 in this plane P₄, about a virtual pivot axis X₂-X′₂. In addition to being the plane of the mechanical oscillator 7, the plane P₄ is thus the plane of oscillation of the balance 6.

In the example represented, each of the resiliently flexible blades 23a and 23b is straight, which could however not always be the case. The first resiliently flexible blade 23a and the third resiliently flexible blade 23b extend in the same plane P₂, which could not be the case. The second resiliently flexible blade 23a and the fourth resiliently flexible blade 23b extend in the same plane P₃, which could not be the case. Intersecting at the coupling part 27, the planes P₂ and P₃ are the above-mentioned ruled surfaces and are perpendicular to the plane P₄.

The coupling part 27 is located at a distance from the first ends 24 and 25. Preferably it is located precisely at equal distance from these first ends 24 and 25. The virtual pivot axis X₂-X′₂ is centered on the coupling part 27. It remains substantially in the plane of symmetry P₁ when the balance 6 oscillates.

Besides the fact that they support the balance 6 in such a way that it can oscillate at an angle about its virtual pivot axis X₂-X′₂, the resiliently flexible blades 23a and 23b resiliently return this balance 6 to a dead point position, which is the position the balance 6 occupies in FIGS. 2 to 5.

In FIG. 5, the angle α is the angle between the planes P₂ and P₃. More precisely, this angle α is the angle at which the first end 24 of one of the resiliently flexible blades 23a and the first end 24 of the other resiliently flexible blade 23a are angularly offset one with respect to the other about an axis which coincides with the virtual pivot axis X₂-X′₂ in the example represented and which is more precisely the axis perpendicular to the plane P₄ and centered on the coupling part 27. The angle at which the first ends 25 are angularly offset one with respect to the other could not have the same value as the angle at which the first ends 24 are angularly offset one with respect to the other. In the example represented, the angle α is also the angle at which the first ends 25 of the resiliently flexible blades 23b are angularly offset one with respect to the other about the axis perpendicular to the plane P₄ and centered on the coupling part 27. The angle α advantageously ranges between 80° and 150°. Preferably the angle is on the order of 120°.

It has been discovered that the angles α ranging between 80° and 150° are among the angles most disfavorable to the appearance of parasitic vibrational modes, that is to say vibrational modes other than that in which the balance 6 oscillates at an angle about its virtual pivot axis X₂-X′₂, in the plane of oscillation P₄. It has been discovered that an angle α on the order of 120° gives the best results in terms of the struggle against the appearance of the above-mentioned parasitic vibrational modes.

As the balance 6 is mounted in a pivoting way without resort to a retaining pin and guided by two bearings, the friction at such bearings does not exist and the losses due to friction are greatly reduced, so that the mechanical oscillator 7 has an excellent quality factor.

Moreover, the absence of friction at the retaining bearings of an arbor translates into an absence of attrition and the uselessness of a lubricant.

The absence of pivots and of bearings guiding these pivots in the mechanical oscillator 7 has still another advantage. This other advantage is that the mechanical oscillator 7 displays an operation with little or no sensitivity to the orientation of this mechanical oscillator 7 with respect to the direction of gravity. Conversely, when a balance is mounted by means of two pivots and two bearings guiding these pivots, the friction between the pivots and the bearings is a function of the orientation of the balance with respect to the direction of gravity.

In the example represented, the resiliently flexible blades 23a are two in number. According to a variant (not shown), and not departing from the scope of the invention, more than two resiliently flexible blades 23a could connect the mounting base 18 to the coupling part 27.

In the example represented, the resiliently flexible blades 23b are two in number. According to a variant (not shown), and not departing from the scope of the invention, more than two resiliently flexible blades 23b could connect the coupling part 27 to the balance 6.

Returning to FIG. 3, the balance 6 comprises two flat wings 28 that the crosspiece 21 connects one to the other. Each leaf 28 bears one inertia block 16 and two inertia blocks 17. These inertia blocks 16 and 17 have the function of increasing the inertia of the balance 6 with respect to its pivot axis X₂-X′₂. The inertia blocks 17 are mounted slit rings and are distributed on the four vertices of a rectangle. As they can be pivoted on themselves, these inertia blocks 17 make it possible to modify the inertia of the balance 6 and thus to adjust the frequency of the mechanical oscillator 7.

The inertia blocks 16 and 17 can be made of a same material or not. The rest of the balance 6 is made of a material whose density is less than that of the material or materials constituting the inertia blocks 16 and 17. In this way, the ratio between the inertia of the balance 6 with respect to its pivot axis X₂-X′₂ and the weight of this balance 6 is increased, so that the mechanical oscillator 7 has little sensitivity to shocks while having an increased regulating capability.

Preferably, the barycenter of the balance 6 is located substantially on the virtual pivot axis X₂-X′₂ and at the coupling part 27.

Returning to FIG. 5, the entry pallet 13 and the exit pallet 14 are both rigid. They are moreover rigidly connected to the balance 6, insofar as the pallet fork 5 is rigidly fixed to the crosspiece 21, by means of two joining pins 29 in the example represented.

In the present description and in the attached claims, the terms “upstream” and “downstream”, as well as similar terms, refer to the direction of progression of a tooth 15 at the pallets 13 and 14.

Each pallet 13 or 14 comprises a resting surface 31 intended to stop temporarily each tooth 15 going downstream, as well as an impulse surface 32 intended to receive an impulse from each tooth 15, that is to say a push by which an energy for maintaining the oscillations of the mechanical oscillator 7 is transferred from the motor organ of the barrel 1 to the mechanical oscillator 7.

Each resting surface 31 is formed by an upstream side of one of the pallets 13 and 14. Each resting surface 31 is curved in the direction of its length in such a way as to curve towards the other resting surface 31. Each resting surface 31 has a constant or substantially constant radius of curvature R₁ or R₂, as well as a center of curvature located, in a substantially fixed way, on the virtual pivot axis X₂-X′₂.

Each impulse surface 32 is a terminal surface at the end of one of the pallets 13 and 14.

Preferably, the mounting base 18, the resiliently flexible blades 23a and 23b, as well as the balance 6, with the exception of the inertial blocks 16 and 17, form part of a same single piece made of a monocrystalline material, in particular a silicon-based or quartz-based monocrystalline material. In the represented example, this same single piece is preferably mostly made of silicon, in which case it preferably has a superficial coating of silicon oxide. For example, the mechanical oscillator 7, with the exception of the inertia blocks 16 and 17, can be cut from a silicon slice, also called a wafer, by deep reactive ion etching, that is to say by implementing the method commonly called “DRIE” (acronym for “Deep Reactive Ion Etching”). It will be noted that the resiliently flexible blades 23a and 23b are easily produced by means of this DRIE process.

The inertia blocks 16 and 17 can be metallic. In the represented example they are made of gold. The inertia blocks 16 can be obtained by galvanic growth.

Preferably the pallet fork is a single piece made of a monocrystalline material, in particular a silicon-based or quartz-based monocrystalline material. In the represented example, the pallet fork 5 is preferably made mostly of silicon, in which case it preferably has a superficial layer of silicon oxide. For example, the pallet fork 5 can be cut from a silicon slice, also called a water, by deep reactive ion etching, that is to say by implementing the method commonly called “DRIE”. At least at their resting surfaces 31 and their impulse surfaces 32, the pallets 13 and 14 are preferably covered with a coating having the function of reducing the friction coefficient and increasing the resistance to wear and tear. For example, this coating can be of diamond, in particular of polycristalline diamond or of DLC (acronym for Diamond-Like Carbon), that is to say carbon in the form of amorphous diamond, or even in graphene. The teeth 15 of the escapement wheel 11 can likewise be at least locally covered by such a coating to have the function of reducing the friction coefficient and increasing the resistance to wear and tear.

Preferably, the two joining pins 29 are made of a titanium alloy, for example the alloy Ti6Al4V, and keep assembled two elements having a core of silicon, i.e. the crosspiece 21 and the pallet fork 5.

Without departing from the scope of the invention, the mechanical oscillator 7 and/or the pallet fork 5 and/or the two joining pins 29 can be made of materials other than those mentioned above. For example, all or part of the mechanical oscillator 7 and/or of the pallet fork 5 can be made with the aid of the “LiGA” process (acronym for “lithography, electroplating and molding”). Likewise, all or part of the mechanical oscillator 7 and/or pallet fork 5 can be cut from a plate of metal, by laser.

Thus, as can be seen from FIG. 2, the adjusting mechanism 9 has a particularly simple composition. In particular, the same means, i.e. the resiliently flexible blades 23a and 23b, make the pallet fork 5 and the balance 6 pivot together. These means have an operation which does not produce friction or practically no friction, as has already been mentioned in the foregoing. By way of comparison, an adjusting mechanism resulting from the association of a Swiss lever escapement and a balance and spiral mechanical oscillator has an operation in which friction occurs at the bearings guiding the arbor for support of the pallet fork and at the bearings guiding the arbor for support of the balance.

The return torque exerted by the resiliently flexible blades 23a and 23b is substantially proportional to the angle at which the balance 6 is pivoted, departing from its dead point position, about the virtual pivot axis X₂-X′2. This contributes to conferring a good isochronism to the mechanical oscillator 7.

Moreover, when the balance 6 oscillates, its center of gravity remains in the plane of symmetry P₁, that is to say it does not deviate from, or practically not from, this plane of symmetry P₁ on one side or the other. This likewise contributes to good performance of the mechanical oscillator 7 in terms of isochronism.

By way of comparison, in the oscillator described in the above-mentioned Swiss patent application CH 709 291, the pivot axis oscillates at an angle during operation and the center of gravity of the balance does the same by having the effect of an imbalance or disequilibrium.

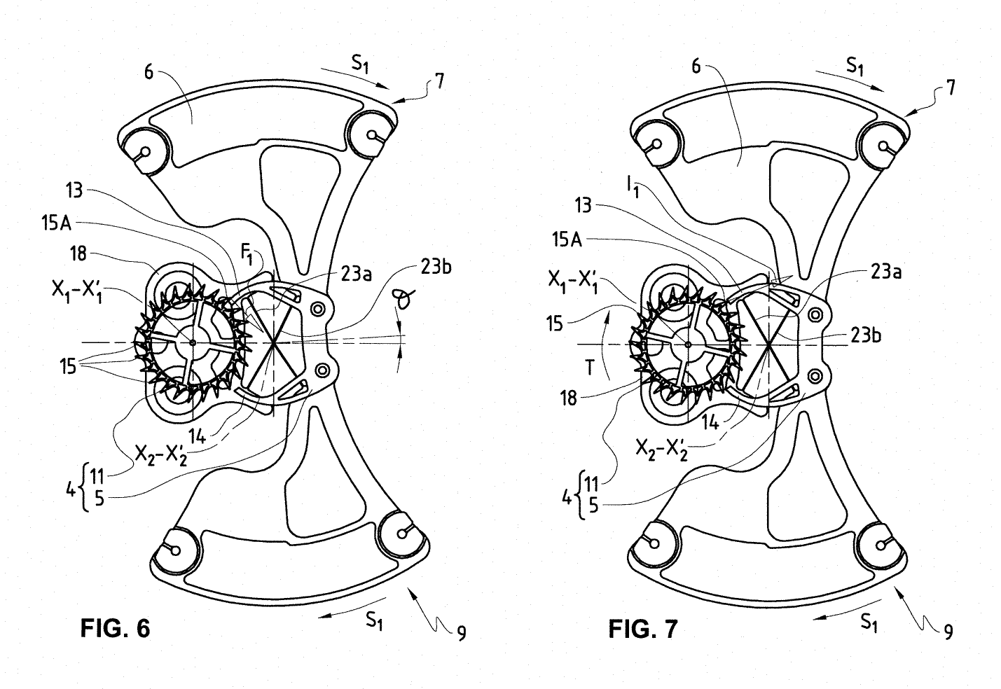

FIGS. 6 to 9 each illustrate one of a plurality of states in which the adjusting mechanism 9 is found during its operation. In operation, the angular amplitude of the oscillations of the balance 6 is preferably on the order of 6 degrees, which is the case in the example represented. This angular amplitude is compatible with the use of a dead-beat escapement such as the escapement 4. Preferably, the mechanical oscillator 7 is dimensioned to oscillate at a frequency on the order of 25 Hz, which is the case in the example represented. Other angular amplitudes and other oscillation frequencies can likewise be used without departing from the scope of the invention.

In FIG. 6, the balance 6 is offset angularly by an angle θ, about its virtual pivot axis X₂-X′₂, with respect to its dead point position. It pivots in the direction S₁, toward its dead point position, under the return effect exerted by the resiliently flexible blades 23a and 23b. The entry pallet 13 catches a tooth 15A of the toothing 12 and, doing so, blocks the escapement wheel 11 against the torque coming from the barrel 1.

Still in FIG. 6, the resting surface 31 of the entry pallet 13 slides on the tooth 15A. Thanks to the curvature of this resting surface 31, the direction of the force F₁ applied by the tooth 15A on the entry pallet 13 passes substantially through the virtual pivot axis X2-X′2. This force F₁ thus does not influence or only slightly influences the oscillation of the balance 6, and this whatever its intensity, which decreases as the mainspring 1 unloads. This contributes to a good isochronism of the mechanical oscillator 7. With regard to the curvature of the resting surface 31 of the entry pallet 13, it will be noted that, when this resting surface 31 slides in one direction then in the other on the tooth 15A, this tooth 15A remains immobile or practically immobile, that is to say it does not displace itself or practically does not displace itself toward the upstream, in the sense of a recoil, or toward the downstream, in the sense of an advance.

The state illustrated in FIG. 7 follows that illustrated in FIG. 6. In this FIG. 7, the tooth 15A is released and the escapement wheel 11 turns on itself under the action of the torque coming from the barrel 1, which is indicated by the arrow T. The tooth 15A applies an impulse I₁ on the impulse surface 32 of the entry pallet 13. This impulse I₁ is exerted in the direction S₁, that is to say in the direction in which the pivoting of the balance 6 has then taken place about the virtual pivot axis X₂-X′₂.

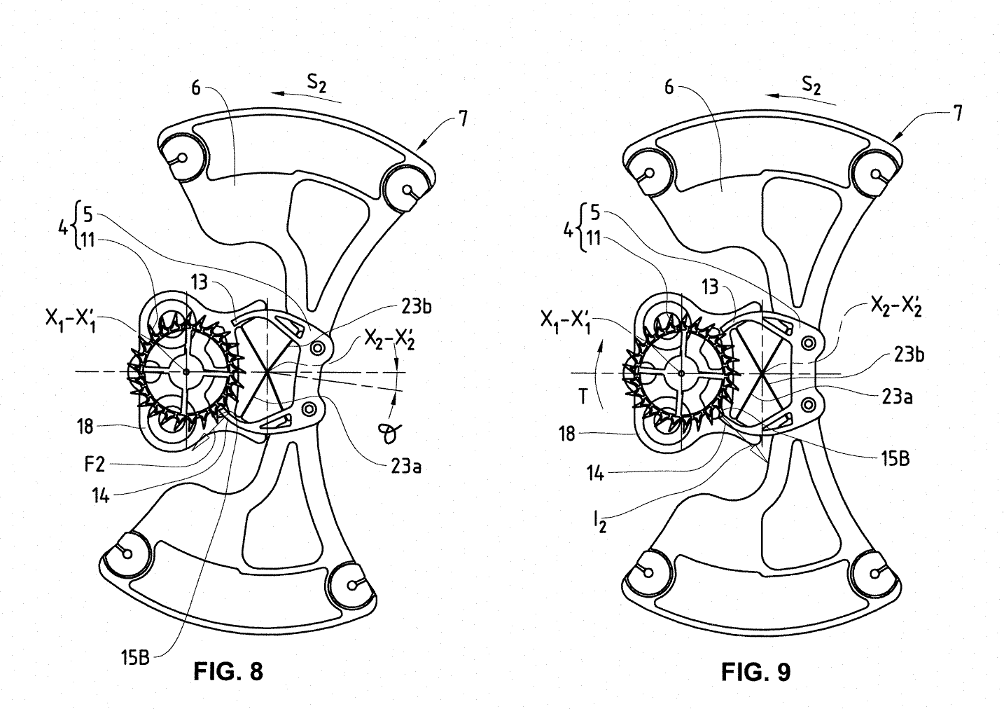

The pivoting of the balance 6 about the virtual pivot axis X₂-X′₂ continues in the direction S₁ then reverses, whereupon the adjusting mechanism 9 is as illustrated in FIG. 8.

In this FIG. 8, the balance 6 is offset angularly by an angle θ, about its virtual pivot axis X₂-X′₂, with respect to its dead point position. It pivots in the direction S₂, toward its dead point position, under the return effect exerted by the resiliently flexible blades 23a and 23b. The exit pallet 14 catches a tooth 15B of the toothing 12 and, doing so, blocks the escapement wheel 11 against the torque coming from the barrel 1.

Still in FIG. 8, the resting surface 31 of the exit pallet 14 slides on the tooth 15B. Thanks to the curvature of this resting surface 31, the direction of the force F2 applied by the tooth 15B on the exit pallet 14 passes substantially through the virtual pivot axis X₂-X′₂. This force F₂ thus does not influence or only slightly influences the oscillation of the balance 6, and this whatever its intensity, which decreases as the mainspring 1 unloads. This contributes to a good isochronism of the mechanical oscillator 7. With regard to the curvature of the resting surface 31 of the exit pallet 14, it will be noted that, when this resting surface 31 slides in one direction then in the other on the tooth 15B, this tooth 15B remains immobile or practically immobile, that is to say it does not displace itself or practically does not displace itself toward the upstream, in the sense of a recoil, or toward the downstream, in the sense of an advance.

The state illustrated in FIG. 9 follows that illustrated in FIG. 8. In this FIG. 9, the tooth 15B is released and the escapement wheel 11 turns on itself under the action of the torque coming from the barrel 1, which is indicated by the arrow T. The tooth 15B applies an impulse 12 on the impulse surface 32 of the exit pallet 14. This impulse 12 is exerted in the direction S₂, that is to say in the direction in which the pivoting of the balance 6 has then taken place about the virtual pivot axis X₂-X′₂.

It will be noted that, during operation, the torque coming from the barrel 1 does not interfere with or practically does not interfere with the oscillations of the balance 6, except during the impulse phases, that is to say during the phases in which the impulses I₁ and I₂ are applied.

By way of comparison, the situation is very different in the timepiece movement proposed in the above-mentioned European patent application EP 1 736 838. Indeed, it has been found that in this timepiece movement, the balance is continuously coupled to the mainspring. In other words, the return torque being exerted on the balance is composed of the return torque produced by the resilient blades supporting the balance and by a torque produced by the mainspring. Therefore, in the timepiece movement proposed in the above-mentioned European patent application EP 1 736 838 the frequency of oscillation of the balance depends to a large extent on the degree of winding of the mainspring providing the drive torque for the escapement wheel. This detracts from the precision of time counting since the degree of winding of the mainspring is not constant over time.

The invention is not limited to the embodiment described in the foregoing and other arrangements producing a virtual pivot can be employed. In particular, the resiliently flexible blades 23a and 23b can be disposed differently, one with respect to the other, without departing from the scope of the invention. For example, they can be designed as in the above-mentioned Swiss patent application CH 709 291, even if the arrangement represented in FIG. 3 is advantageous for at least some of the reasons previously mentioned. Still without departing from the scope of the invention, the two resiliently flexible blades can be not crossed, while being inclined one with respect to the other in such a way that, if these two resiliently flexible blades each extend in one of two planes, these two planes intersect, for example at the balance or at the mounting base.

Furthermore, a mechanism for adjusting the average speed according to the invention can be installed in a tourbillon.

The invention can be implemented in diverse timepieces. As it has a compact design, the invention can be implemented in particular in a watch such as a wristwatch.

1. An adjusting mechanism for adjusting an average speed in a timepiece movement, comprising:
an escapement wheel;
a mechanical oscillator, the mechanical oscillator comprising,
a balance; and
a plurality of resiliently flexible blades, which are resiliently flexible in an oscillation plane, and which support and return the balance in such a way that the balance oscillates at an angle in the oscillation plane; and
a pallet fork comprising two rigid pallets which are rigidly connected to the balance and are arranged to co-operate alternately with a toothing of the escapement wheel when the balance oscillates at an angle.

2. The adjusting mechanism according to claim 1, wherein each pallet includes an upstream side forming a resting surface to block successively the teeth of the toothing toward a downstream counter to a driving motor torque of the escapement wheel, each pallet including an end surface forming an impulse surface to receive successively impulses from the toothing.

3. The adjusting mechanism according to claim 2, wherein each resting surface curves toward the other resting surface.

4. The adjusting mechanism according to claim 3, wherein each resting surface curves toward the other resting surface in a way so as to be able to slide on a tooth of the toothing, during an angular oscillation of the balance, while not causing or substantially not causing rotation movement of the escapement wheel.

5. The adjusting mechanism according to claim 3, wherein each resting surface has a substantially constant curvature in the direction of its length and has a center of curvature always positioned substantially at the same place, substantially on a virtual pivot axis of the balance.

6. The adjusting mechanism according to claim 1, wherein the mechanical oscillator comprises a mounting base, at least part of the resiliently flexible blades each comprising an end rigidly joined to the mounting base, at least part of the resiliently flexible blades each comprising an end rigidly joined to the balance.

7. The adjusting mechanism according to claim 1, wherein the mechanical oscillator comprises a mounting base, at least a first and a second resiliently flexible blade among the resiliently flexible blades each comprising two opposite ends, including a first end rigidly joined to the mounting base and a second end, at least a third and a fourth resiliently flexible blade among the resiliently flexible blades each comprising two opposite ends, including a first end rigidly joined to the balance and a second end, and in that the second ends of the first, second, third, and fourth resiliently flexible blades at least are rigidly joined to one another.

8. The adjusting mechanism according to claim 7, wherein the second ends of the first, second, third, and fourth resiliently flexible blades are rigidly joined to one another by a coupling part, the first ends of the first and second resiliently flexible blades being angularly offset one with respect to the other by an angle ranging between 80° and 150°, about an axis perpendicular to the plane of oscillation and centered on the coupling part, the first ends of the third, and fourth resiliently flexible blades being angularly offset one with respect to the other by an angle ranging between 80° and 150°, about an axis perpendicular to the plane of oscillation and centered on the coupling part.

9. The adjusting mechanism according to claim 8, wherein the first ends of the first and second resiliently flexible blades are offset one with respect to the other by an angle on the order of 120°, about the axis perpendicular to the plane of oscillation and centered on the coupling part, the first ends of the third, and fourth resiliently flexible blades being angularly offset one with respect to the other by an angle on the order of 120°, about the axis perpendicular to the plane of oscillation and centered on the coupling part.

10. The adjusting mechanism according to claim 7, wherein the second ends of the first, second, third, and fourth resiliently flexible blades are rigidly joined to one another by a coupling part through which passes a virtual pivot axis of the balance.

11. The adjusting mechanism according to claim 7, wherein the second ends of the first, second, third, and fourth resiliently flexible blades are rigidly joined to one another by a coupling part, the balance having a center of gravity located substantially at the coupling part.

12. The adjusting mechanism according to claim 1, wherein the mechanical oscillator comprises a mounting base including two stops which are travel end stops for the balance and which define a maximal angular course of the balance by preventing the balance from going beyond two opposite ends of the maximal angular course.

13. The adjusting mechanism according to claim 1, wherein the balance includes two opposite wings and a crosspiece connecting the two wings together, at least part of the resiliently flexible blades each comprising an end rigidly joined to said crosspiece.

14. The adjusting mechanism according to claim 1, wherein the mechanical oscillator comprises a mounting base, at least part of the mounting base, at least part of the balance and the resiliently flexible blades being integral with one another.

15. A timepiece movement, comprising:
a motor organ;
a gear train driven by the motor organ; and,
an adjusting mechanism for adjusting an average speed in the timepiece movement, the adjusting mechanism comprising:
an escapement wheel driven by the gear train;
a mechanical oscillator, the mechanical oscillator comprising:
a balance; and
a plurality of resiliently flexible blades, which are resiliently flexible in an oscillation plane, and which support and return the balance in such a way that the balance oscillates at an angle in the oscillation plane; and
a pallet fork comprising two rigid pallets which are rigidly connected to the balance and are arranged to co-operate alternately with a toothing of the escapement wheel when the balance oscillates at an angle.
